(19) United States
(12) Patent Application Publication
(10) Pub. No.: US 2020/0284973 A1
(43) Pub. Date: Sep. 10, 2020

(54) ILLUMINATING DEVICE WITH MULTIPLE WAVEGUIDES CONNECTED BY A BRIDGE

(71) Applicant: VOLVO CAR CORPORATION, Goteborg (SE)

(72) Inventor: Markus ANDERSSON, Göteborg (SE)

(21) Appl. No.: 16/296,894

(22) Filed: Mar. 8, 2019

(51) Int. Cl. F21V 8/00; B60Q 3/64

(52) U.S. Cl. CPC G02B 6/0088; G02B 6/0078; B60Q 3/64

(57) ABSTRACT

An illuminating device for distributing light from a light source is disclosed. The light illuminating device containing a first waveguide and a second waveguide connected to the first waveguide by a bridge. The bridge is configured to maintain the first waveguide and the second waveguide in spaced relation, such that an air gap exists between the first and second waveguides. The bridge aligns the first and second waveguides to ensure a consistent gap to provide reliable and consistent lighting output and distribution.

### TECHNICAL FIELD

This invention relates to illuminating devices for distributing light from a light source. In particular, the illuminating device is manufactured as a single piece to ensure robust and consistent lighting output.

### BACKGROUND ART

Current light-emitting diode (LED) lighting for automobile interiors, such as ceiling lights, generally includes an illuminating device for distributing the light. Typically, the illuminating device contains two waveguides: a first waveguide conducting light in a first direction and extracting the light in a second direction orthogonal to the first direction as the light travels in the first direction; and, a second waveguide receiving the extracted light from the first waveguide and forming an illuminating surface. An example of such a lighting assembly is disclosed, e.g. in U.S. Patent Application Publication No. 2010/0315833 to Holman et al. The two waveguides must be aligned within a tight tolerance for reliable and consistent lighting output. Current illuminating devices, however, are prone to misalignment of the waveguides, either during assembly or during use of the light, resulting in poor and inconsistent light output and distribution.

Therefore, there remains a need for an illuminating device that provides reliable and consistent lighting output and distribution, by providing robust alignment of the waveguides.

### SUMMARY OF THE INVENTION

An aspect of the present invention provides a light illuminating device containing a first waveguide and a second waveguide connected to the first waveguide by a bridge. The bridge is configured to align and to maintain the first waveguide and the second waveguide in spaced relation, such that an air gap exists between the first and second waveguides. The bridge aligns the first and second waveguides to ensure a consistent gap to provide reliable and consistent lighting output and distribution. The first waveguide is configured to receive light from a light source to a receiving end, conducting the light along its length in the x-direction, and reflecting the light in the y-direction toward the second waveguide. The second waveguide is configured to receive light from the first waveguide, conducting the light along its width in the y-direction, and reflecting the light in the z-direction through a bottom surface to illuminate a region below the second waveguide.

Another aspect of the present invention provides a lighting apparatus containing the illuminating device described above. The lighting apparatus may be used in interior lighting, such as for an automobile or a room

A further aspect of the present invention provides an automobile containing a lighting apparatus described above.

Methods for making and using the different aspects of the present invention are also provided.

Other aspects of the invention, including apparatuses, devices, kits, processes, and the like which constitute part of the invention, will become more apparent upon reading the following detailed description of the exemplary embodiments.

### BRIEF DESCRIPTION OF THE DRAWINGS

The foregoing background and summary, as well as the following detailed description, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is perspective view of an illuminating device in accordance to the present invention;

FIG. 2 is a side view of the illuminating device;

FIG. 3 is a bottom view of the illuminating device; and

FIG. 4 is an alternate bottom view of the illuminating device.

### DESCRIPTION OF EMBODIMENTS

The exemplary embodiment of the present invention will now be described with the reference to accompanying drawings. The following description of the preferred embodiment is merely exemplary in nature and is in no way intended to limit the invention, its application, or uses.

For purposes of the following description, certain terminology is used in the following description for convenience only and is not limiting. The characterizations of various components and orientations described herein as being “front,” “back,” “vertical,” “horizontal,” “upright,” “right,” ‘left,” “side,” “top,” “bottom,” “above,” “below,” or the like designate directions in the drawings to which reference is made and are relative characterizations only based upon the particular position or orientation of a given component as illustrated. These terms shall not be regarded as limiting the invention. The words “downward” and “upward” refer to position in a vertical direction relative to a geometric center of the apparatus of the present invention and designated parts thereof. The terminology includes the words above specifically mentioned, derivatives thereof and words of similar import.

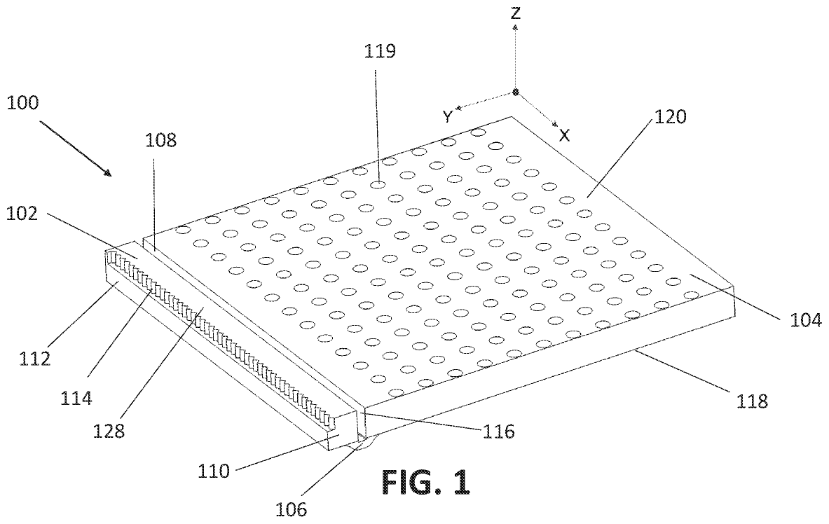

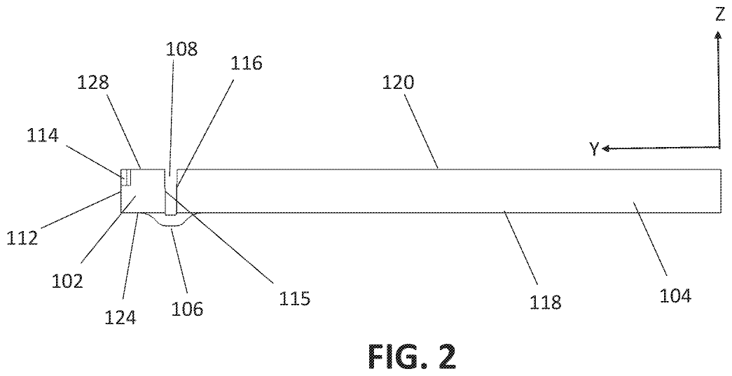

Referring to FIGS. 1-2, the illuminating device 100 contains a first waveguide 102 and a second waveguide 104 connected to the first waveguide 102 by a bridge 106. The bridge 106 is configured to align the first waveguide 102 and the second waveguide 103 in spaced relation, such that an air gap 108 exists between the first and second waveguides 102 and 104.

The first waveguide 102 is preferably an elongated bar having a length in the x-direction, a width in the y-direction, and a thickness in the z-direction, as noted in FIG. 1, where the x-, y-, and z-directions are orthogonal axes in a Cartesian coordinate frame. Preferably, the first waveguide 102 contains a pre-selected angular light distribution in each of the x-, y- and z-direction. The first waveguide 102 is configured to receive light from a light source to a receiving end 110, conducting the light long its length in the x-direction, and extracting and directing the light in the y-direction toward the second waveguide 104. The extracted light is emitted from an emitting surface 115 of the first waveguide 102 which faces the second waveguide 104.

As one example, the light source is an LED-based light emitter. The LED emitter may contain a single LED having one or more LED chips coupled with appropriate optics designed to collect and transport the light efficiently from the LED emitter to the receiving end 110 of the first waveguide 102. Preferably, the light entering the receiving end 110 is collimated in the x-direction. Other LED light emitters known in the art are also contemplated for use with the present invention.

The first waveguide 102 preferably has a substantially, square (or rectangular) cross-section and transmits input light flowing within the waveguide by total internal reflection. The side 112 of the first waveguide 102 (the side farthest from the second waveguide 104) contains one or more light extracting structures 114 for extracting a fraction of the light flowing within first waveguide 102 as the light strikes the light extracting structure 114 along the length of the first waveguide 102, and redirecting the extracted light uniformly over the length of the first waveguide 102 substantially in the y-direction through the air gap 108 and to the second waveguide 104. The light extracting structure 114 may be those known in the art, such as gratings, focusing lens, microprisms, other microoptical features, or combinations thereof, with microprisms being the preferred light extracting feature. One light extracting structure 114 is shown, e.g., in U.S. Patent Application Publication No. 2010/0315833, which is incorporated herein by reference. The light extracting structure 114 may be formed directly on the side 112 of first waveguide 102 or attached thereto, e.g. as a film layer. In an embodiment, the light extracting structure 114 may be in the form of a micro-patterned layer and/or having one or more reflecting surfaces (e.g. mirrors). In another embodiment, the extracting structure 114 may be a plurality of protruding structures on the side 112 of the first waveguide 102. Preferably, the plurality of protruding structures may have a triangular cross-sectional shape forming a series of microprisms. Depending on the size of the light source, the first waveguide 102 may have a thickness of about 1 mm to about 5 mm, a width of about 1 mm to about 5 mm, and a length of about 10 to about 600 mm. For example, the first wave guide 102 may have a cross-section of about 2 mm×3 mm, about 3 mm×2 mm, about 4 mm×5 mm, etc.

The second waveguide 104 is preferably a flat, square (or rectangular) plate having a length in the x-direction, a width in the y-direction, and a thickness in the z-direction, as noted in FIG. 1. The second waveguide 104 is configured to receive light from the first waveguide 102 to a receiving edge 116, conducting the light long its width in the y-direction, and extracting and directing the light in the z-direction through the bottom surface 118. Preferably, the second waveguide. 104 contains a preselected angular light distribution in each of the x-, y-, and z-direction. The second waveguide 104 transmits the light flowing therein by total internal reflection in the y-direction. As the light is being conducted in the y-direction, a fraction of the light is extracted and directed in the z-direction by one or more light extracting structures 119 present on the top surface 120 of the second waveguide. 104. The light extracting structure 119 may be the same or different than those on the first wave guide 102 and may be, but is not limited to, gratings, focusing lens, microprisms, other microoptical features, or combinations thereof, with microprisms or other microoptical features being preferred. Preferably, the light extracting structure 119 is configured to redirect the extracted light uniformly over the surface of the first waveguide 102 substantially in the z-direction. Depending on the application, the second waveguide 104 may have a thickness of about 1 mm to about 5 mm, a width of about 10 mm to about 600 min, and a length of about 10 mm to about 600 min. Preferably, the lengths of the first and second waveguides 102 and 104 are the same.

The first and second waveguides 102 and 104 are aligned relative to each other, so that the air gap 108 separates the two waveguides. In proper alignment, the receiving surface 116 of the second waveguide 103 faces the emitting surface 115 of the first waveguide 102, with the gap 108 separating the two surfaces 115 and 116. Preferably, the gap 108 is made as small as possible and is usually limited by production methods. Depending on the application of the illuminating device 100, the gap 108 may be from about 0.8 mm to about 1.5 mm. The width of the gap 108 may vary along the length of the waveguides 102 and 104; however, preferably, the width of the gap 108 is the same along the length of the waveguides 102 and 104.

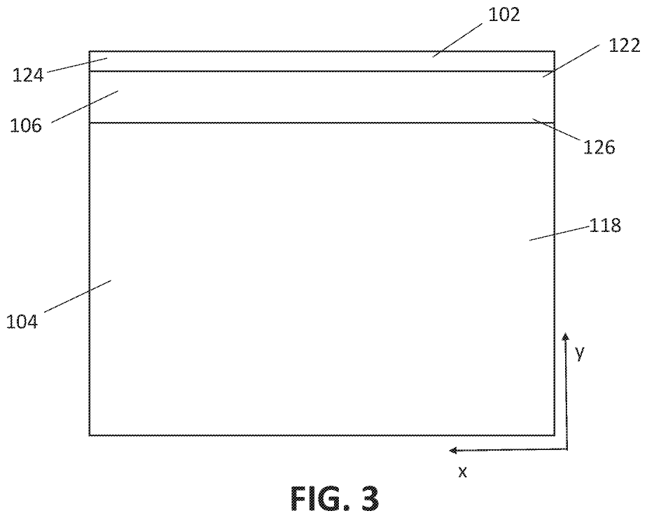

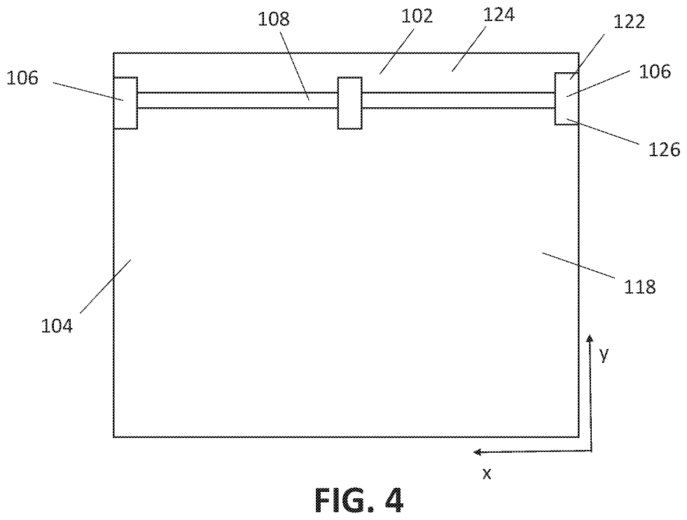

To properly align the first and second waveguides 102 and 104, the bridge 106 is used to connect the two waveguides 102 and 104 and to rigidly hold them apart. The bridge 106 provides a robust mechanism to align the first and second waveguides 102 and 104 to control the width of the gap 108. The bridge 106 contains a first end 122 attached to the bottom surface 124 of the first waveguide 102 and a second end 126 attached to the bottom surface 118 of the second waveguide 104. Importantly, the bridge 106 does not intrude into the gap 108, so that it does not interfere with the light transmission through the gap 108. As such, as shown in FIGS. 1-2, the bridge arches over and does not protrude into the gap 106. As shown in FIG. 3, the illuminating device 100 may contain a single bridge 106 that spans the whole length, or a majority of the length of, the first and second waveguides 102 and 104. Alternatively, as shown in FIG. 4, illuminating device 100 may contain two or more bridges along the lengths of the waveguides 102 and 104. Furthermore, although the drawings show the bridge connecting the bottom surfaces 124 and 118 of the first and second waveguides 102 and 104, respectively, it is also possible for the bridge 106 to connect the top surfaces 128 and 120 or the first and second waveguides 102 and 104, respectively.

The waveguides 102 and 104 may be made of a transparent material, e.g., an optically transparent material. For example, the (optically) transparent material may be optically transmissive to an electromagnetic radiation of the visible light spectrum emitted from the light source. The material is preferably an optically transparent plastic, preferably polymethyl methacrylate acrylate (PMMA), polycarbonate, or combinations thereof. The waveguides 102 and 104 and the bridge 106 may be formed by injection molding, a technique known in the art, of the optical transparent plastic. Preferably, the waveguides 102 and 104 and the bridge 106 are form, e.g. molded, from the same material as a single piece.

In use, the illuminating device 100 receives light from the light source and distributes the light through the bottom surface 118 of the second waveguide 104 to provide illumination in the region below the second waveguide 104. In doing so, the first wave guide 102 receives light from the light source at the receiving end 110, and conducts the light along its length in the x-direction. As the light is being conducted in the first waveguide 102, the light is extracted and directed in the y-direction toward the second waveguide 104 due to the light extracting structure 114 on the first waveguide 102. The reflected light traverses the gap 108 and enters the second waveguide 104 at the receiving edge 116. The second waveguide 104 conducts the light along its width in the y-direction. As the light is being conducted in the first waveguide 102, the light is extracted and directed in the z-direction due to the light extracting structure 119 on the second waveguide. 104. The extracted light exits the second waveguide 104 at its bottom surface 118, to illuminate in the region below the second waveguide 104. The disclosed illuminating device 100 may be used in lighting assembly to provide aesthetically pleasing, sturdy, cost effective lighting for use in interior lighting, such as for an automobile or a room.

Although certain presently preferred embodiments of the invention have been specifically described herein, it will be apparent to those skilled in the art to which the invention pertains that variations and modifications of the various embodiments shown and described herein may be made without departing from the spirit and scope of the invention.

1. An illuminating device, comprising: a first waveguide having a light emitting edge, a separate second waveguide having a light receiving edge, and a bridge connected to respective bottom surfaces of said wave guides holding the first and second separate waveguides in spaced relation such that an air gap exists between the first and second waveguides between said respective light emitting and light receiving edges along an entire length of each of said edges.

2. The illuminating device of claim 1, wherein the first waveguide is a long bar having a length in the x-direction, a width in the y-direction, and a thickness in the z-direction, where in the x-, y-, and z-directions are orthogonal to each other.

3. The illuminating device of claim 2, wherein the first waveguide has a square or rectangular cross-section.

4. The illuminating device of claim 2, wherein the first waveguide is configured to conduct light in the x-direction and extracting and directing the light in the y-direction.

5. The illuminating device of claim 2, wherein the first waveguide contains one or more light extracting structures on a surface thereof opposite said light emitting surface.

6. The illuminating device of claim 5, wherein the one or more light extracting structures are gratings, focusing lens, microprisms, microoptical structures, or combinations thereof.

7. The illuminating device of claim 5, wherein the one or more light extracting structures are formed on the first waveguide or attached to the first waveguide.

8. The illuminating device of claim 1, wherein the second waveguide is a rectangular flat plate having a length in the x-direction, a width in the y-direction, and a thickness in the z-direction, where in the x-, y-, and z-directions are orthogonal to each other.

9. The illuminating device of claim 8, wherein second waveguide is configured to conduct light in the y-direction and extracting and directing the light in the z-direction.

10. The illuminating device of claim 8, wherein the second waveguide contains one or more light extracting structures on a surface thereof orthogonal to said light receiving surface.

11. The illuminating device of claim 10, wherein the one or more light extracting structures are gratings, focusing lens, microprisms, microoptical structures, or combinations thereof.

12. The illuminating device of claim 10, wherein the one or more light extracting structures are formed on the second waveguide or attached to the second waveguide.

13. The illuminating device of claim 1, wherein the bridge contains a first end and a second end, the first end connects to a bottom surface of the first waveguide, the second end connects to a bottom surface of the second waveguide.

14. The illuminating device of claim 1, wherein the bridge arches under the air gap.

15. The illuminating device of claim 1, wherein the air gap has a width of about 0.8 mm to about 1.5 mm.

16. A lighting assembly comprising the illuminating device of claim 1 and a light source.

17. The lighting assembly of claim 16, wherein the light source is an LED-based light emitter.

18. A method for distributing light, comprising the steps of:
a) providing an illuminating device;
b) conducting light in a first waveguide in a first direction;
c) while the light is being conducted in the first waveguide, extracting and directing the extracted light in a second direction perpendicular to the first direction across an air gap toward a separate second waveguide connected via a bridge, said bridge being connected to respective bottom surfaces of said first and second waveguides, to said first waveguide, said bridge structure providing a continuous air gap along an entire length of a light emitting surface of said first waveguide and a light receiving surface of said second waveguide; and
d) conducting the light in the second waveguide in the second direction; and
e) while the light is being conducted in the second waveguide, extracting and directing the extracted light in a third direction perpendicular to both the first and second directions.

19. The method of claim 18, wherein step b) is performed via providing a light source at one end of the first waveguide.

20. The method of claim 19, wherein the light source is an LED-based light emitter.
